(19) United States
(12) Patent Application Publication
(10) Pub. No.: US 2007/0234612 A1
(43) Pub. Date: Oct. 11, 2007

(54) Luminescent motor vehicle signage system

(76) Inventors: Gary Clifford Corbishley, Uttoxeter (GB); Sandra Jane Corbishley, Uttoxeter (GB)

Correspondence Address: Galasso & Associates, LP, P. O. Box 26503, Austin, TX, 78755-0503, US

(21) Appl. No.: 11/397,266

(22) Filed: Apr. 4, 2006

(51) Int. Cl. G09F 21/04

(52) U.S. Cl. 40/591

(57) ABSTRACT

A luminescent motor vehicle signage system is disclosed. The system includes a housing including a cavity for storing a removable translucent signage. The housing includes a front portion having a clear plastic material formed into a window for displaying the removable translucent signage. The system further includes an illumination chamber provided coupled to the housing and placed at a distance behind the window and the cavity. The system also includes an access panel placed along an end of the housing and operable to eject the removable translucent signage when stored within the housing.

### FIELD OF THE DISCLOSURE

The present invention generally relates to signage, and more particularly, to a luminescent motor vehicle signage system.

### BACKGROUND

Some commercial motor vehicles are typically used for activities such as delivering goods, hauling materials, or transporting cargo between various locations. Such activities usually require use of a cargo truck, travel trailer, or other commercial transportation vehicle that may allow for loading materials within a portion the vehicle when transporting between locations.

Various types of companies that provide such services include distribution or trucking companies that maintain motor vehicles or delivery trucks for delivering goods to various locations at specific times. Such distribution companies may include signage indicating the name of the distribution company or the name of the company goods or products are being delivered for.

However, several companies may not have a need for using distribution or delivery services on a daily basis. For example, some companies may only need deliveries once or twice a week. As such, companies may subcontract independent vehicle owners or operators to transport goods on a periodic basis. Such independent contractors may use their own vehicle to transport goods for the company. However, such contractors may not include signage or advertising indicating the company name the goods are being transported for. As such, what is needed is an inexpensive system for allowing a vehicle operator to display various signs for transports of different goods or materials.

### BRIEF DESCRIPTION OF THE DRAWINGS

A more complete understanding of the present embodiments and advantages thereof may be acquired by referring to the following description taken in conjunction with the accompanying drawings, in which like reference numbers indicate like features, and wherein:

FIG. 1 illustrates a luminescent motor vehicle signage system according to one aspect of the present invention;

FIG. 2 illustrates a side perspective view of a luminescent motor vehicle signage system and access door according to one aspect of the invention: and

FIG. 3 illustrates a motor vehicle having a mounted luminescent motor vehicle signage system according to one aspect of the invention.

### DETAILED DESCRIPTION

A luminescent motor vehicle signage system is disclosed. According to one aspect, a luminescent motor vehicle signage includes an elongated housing having a first end and a second end and a cavity between operable to securely hold and display removable signage. The elongated housing is operable to be coupled to an exterior contour of a motor vehicle. The system further includes a sealed illumination chamber housing positioned along a rear portion of the elongated housing operable to illuminate the removable signage.

According to another aspect of the invention, a luminescent motor vehicle signage system includes a housing including a cavity for storing removable translucent signage. The housing includes a front portion having a clear plastic material formed into a window for displaying the removable translucent signage. The system further includes an illumination chamber coupled to the housing and placed at a distance behind the window and the cavity. The system also includes an access panel placed along one end of the housing and operable to eject the removable translucent signage when stored within the housing.

According to a further aspect of the invention, a luminescent motor vehicle signage system includes a rectangular housing operable to be coupled to an exterior portion of an automobile. The rectangular housing includes a spring loaded access panel positioned at a first end of the rectangular housing and operable to remove and replace a removable opaque signage. The system further includes a fluorescent illumination chamber positioned behind the opaque signage and operable to illuminate the removable opaque signage when placed within the rectangular housing and a rubber seal coupled to a rear portion of the rectangular housing and operable to protect contents within the rectangular housing from environmental elements.

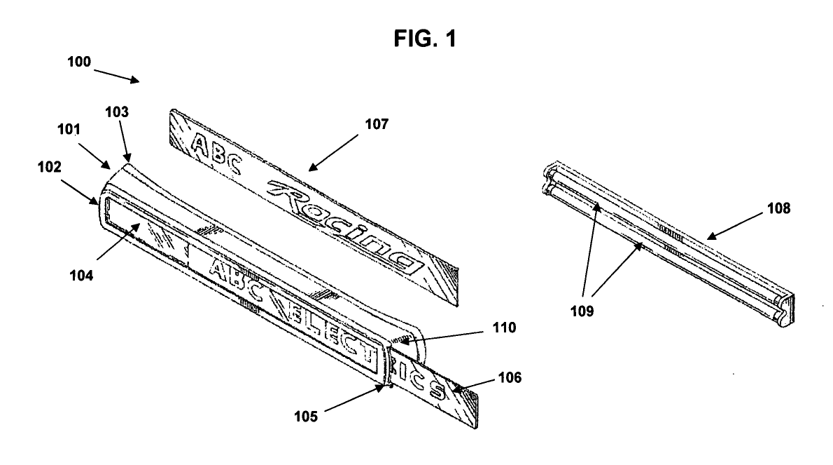

FIG. 1 illustrates a luminescent motor vehicle signage system according to one aspect of the present invention. A luminescent motor vehicle signage system, illustrated generally as signage system 100, includes a housing 101 shaped generally as a rectangle and including a front window portion 102 having a plastic or clear plexiglass material 104 positioned along a length of housing 101. Housing 101 further includes a rear portion 103 having a rubber material gasket operable to protect a surface of a motor vehicle when signage system 100 is mounted to a vehicle. Rear portion 103 having a rubber material or gasket ensures that a housing 101 conforms to a surface of a vehicle while ensuring that environmental elements such as wind or precipitation is not introduced to rear portion 103 of housing 100. Rear portion 303 may also be contoured or tapered as needed. For example, rear portion 103 having a rubber material or gasket ensures that an aerodynamic interface is maintained between a surface of a motor vehicle through reducing any turbulent air that may occur at various speeds of a motor vehicle. In this manner, damage to a motor vehicle and/or vehicle signage is reduced or minimized.

Signage system 100 further includes an illumination chamber 110 formed from a plastic material and sized to house a fixture 108 having illuminators 109 such as fluorescent light bulbs 109. Illumination chamber 110 includes a waterproof chamber that protects electronics associated with fixture 108 for illuminating illuminators 109. In this manner, signage system 100 may be employed in a variety of outdoor environments.

Signage system 100 further includes an access panel or door 105 positioned along an end portion of housing 101 and operable to allow access to first sign 106. Access panel 105 cooperates with housing 101 and is spring activated such that signage 106 is egressed from housing 101 when access panel 105 is opened. A user may then remove first sign 106 and replace with second sign 107 as desired. For example, as a user inserts second sign 107 within housing 101, a spring tensioned panel (not expressly shown) located at an opposing end of housing 101 and opposite access panel 105 is compressed as second sign 107 is inserted within housing 101. As such, when a user opens access panel 105, second sign 107 is egressed from housing 101 allowing a user to grasp second sign 107 and remove as desired.

Signage system 100 may further include electronics (not expressly shown) connected to a motor vehicles electrical system to provide power to illumination chamber 110 for illuminating or lighting sign 106. For example, signage system 100 may be coupled to a motor vehicle's lighting system and, upon turning on running lights or headlights, signage system 100 activates illumination chamber 110 and illuminates first sign 106. In another embodiment, signage system 100 may be coupled to an auxiliary power port, such as a twelve-volt power port, of a motor vehicle. In this manner, signage system 100 may be removed from a motor vehicle and installed in another motor vehicle without having to remove any permanent wiring. Other configurations may also be employed.

During use, a user may install first sign 106 by opening access panel 105 and sliding first sign 106 into housing 101 until sign 106 is installed within housing 101. A user may then close access panel 105. Upon a user installing first sign 106, a user may deliver products for a specific company being displayed by first sign 106. Upon completing deliveries, a user may then remove first sign 106 by opening access panel 105. A spring-loaded egress system associated with access panel 105 egresses first sign 106 far enough for a user to grasp and remove first sign 106 from housing 101. A user may then install second sign 107 associated with a second company within housing 101 and close access panel 105 to lock second sign 107 in place. In this manner, a user may easily remove and replace signage when delivering products for multiple companies to provide advertising for each company as needed.

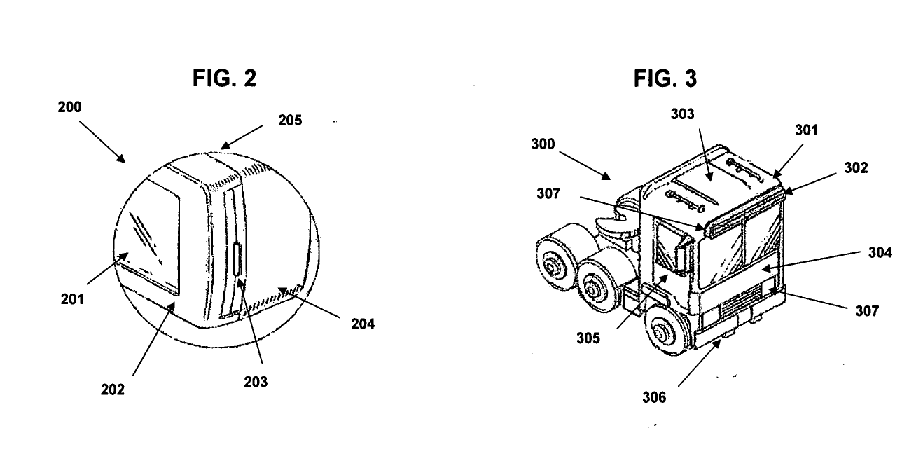

FIG. 2 illustrates a side perspective view of a luminescent motor vehicle signage system and access door according to one aspect of the invention. A portion if a luminescent signage system is illustrated generally at 200 and includes a housing 205 including an illumination chamber 204, a front portion 202 providing a window 201 for displaying signage. Signage system 200 further includes an access panel 203 operable to access and remove and replace signage (not expressly shown). For example, a user may open access panel 203 and if a sign does not exist within housing 205, a user may install a sign through access panel 203 and close access panel 203 to lock or secure a panel within housing 205. When a user desires to remove a sign, a user opens access panel 203 and a spring-loaded egress system (not expressly shown) ejects or egresses an installed sign through the opened access panel 203 sufficient for a user to grasp a sign and remove as needed. In one embodiment, a spring loaded egress system may include a movable internal end portion located at an opposing end to access panel 203 and including a spring-loaded or spring activated such that when a user installs a sign, the movable internal end portion is compressed. As a user opens access panel 203, the tension of the spring is sufficient to move or egress a sign through access panel 203 thereby allowing a user to remove a sign as needed. Other type of egress systems may also be employed by luminescent signage system 200 as needed.

FIG. 3 illustrates a motor vehicle having a mounted luminescent motor vehicle signage system according to one aspect of the invention. A motor vehicle, illustrated as truck 300, operable to be used in association with towing various trailers or delivering goods, materials, etc. Truck 300 includes a truck cab 301 having a top portion or roof 303 and a front end 304. A luminescent signage system 302 is mounted to front end 304 of truck cab 301. Luminescent signage system 302 may be configured as luminescent signage system 100 illustrated in FIG. 1 and is coupled to front end 304 using various coupling techniques or mounts. For example, luminescent signage system 302 may be permanently mounted by coupling sign by bolting, screwing, riveting, etc. along a top of front end 304. Other types of mounting techniques or mechanisms may also be used. In another embodiment, luminescent signage system 302 may be temporarily mounted to front end 304. For example, a tongue and groove mount or magnetic mount may be employed to couple to front end 304 when front end 304. For example, if front end 304 is made of a metallic material that may be magnetized or coupled using magnets, luminescent mounting system 302 may be mounted using a magnetic mount. In another form, rubber seal 307 may provide additional mounting support through providing suction between signage system 302 and front end 304. Other forms of mounting may also be employed.

During use, a user may remove and replace signs as needed through access an access panel of the system and an egress system associated with the system evacuates a sign far enough for a user or vehicle operator standing along door 305 of truck cab 301 to remove and replace a sign as needed. Upon installing a sign, a vehicle operator may then activate luminescent signage system 302 to display a sign stored within signage system 302. For example, luminescent signage system 302 may include a separate activation system such as a switch provided along side of the system (not expressly shown). However, in other embodiments, luminescent signage system 302 may be coupled to a lighting system of truck cab 300 and may be illuminated with running lights 306 and/or headlights 307 are activated.

Note that although an embodiment of the invention has been shown and described in detail herein, along with certain variants thereof, many other varied embodiments that incorporate the teachings of the invention may be easily constructed by those skilled in the art. Benefits, other advantages, and solutions to problems have been described above with regard to specific embodiments. However, the benefits, advantages, solutions to problems, and any element(s) that may cause any benefit, advantage, or solution to occur or become more pronounced are not to be construed as a critical, required, or essential feature or element of any or all the claims. Accordingly, the invention is not intended to be limited to the specific form set forth herein, but on the contrary, it is intended to cover such alternatives, modifications, and equivalents, as can be reasonably included within the spirit and scope of the invention.

What is claimed is:

1. A luminescent motor vehicle signage comprising:
an elongated housing having a first end and a second end and a cavity between operable to securely hold and display removable signage, the elongated housing operable to be coupled to an exterior contour of a motor vehicle; and
a sealed illumination chamber housing positioned along a rear portion of the elongated housing, the sealed illumination chamber operable to illuminate the removable signage.

2. The system of Claim I, wherein the elongated housing further comprises a spring loaded access door operable to provide access to the removable signage to remove and replace the removable signage.

3. The system of claim 1, further comprising a plastic material coupled to a front side of the elongated housing and operable to protect the removable signage from environmental elements.

4. The system of claim 1, wherein the removable signage comprises an opaque plastic material.

5. The system of claim 1, further comprising a rubber seal coupled to a rear portion of the elongated housing to securely couple the elongated housing to the motor vehicle.

6. The system of claim 1, wherein the elongated housing includes a guide for slidingly engaging the removable signage.

7. The system of Claim I, wherein the elongated housing comprises plastic.

8. The system of claim 1, wherein the illumination chamber comprises a fluorescent illuminator.

9. The system of claim 8, wherein the florescent illuminator operates from a direct current power source.

10. A luminescent motor vehicle signage system comprising:
a housing including a cavity for storing a removable translucent signage, the housing including a front portion having a clear plastic material formed into a window for displaying the removable translucent signage;
an illumination chamber provided coupled to the housing and placed at a distance behind the window and the cavity; and
an access panel placed along an end of the housing and operable to eject the removable translucent signage when stored within the housing.

11. The system of claim 10 further comprising a spring-loaded actuator positioned provided in association and at an opposing end to the access panel, the spring-loaded actuator operable to egress the removable translucent signage when the access panel is opened.

12. The system of claim 10 wherein the illumination chamber includes a direct current activation circuit operable to be coupled to an electric circuit of the motor vehicle, the direct current activation circuit operable to activate a fluorescent illuminator stored within the illumination chamber.

13. The system of claim 11, further comprising:
illumination means for illuminating the removable signage stored within the housing;
display means for displaying the signage when inserted within the housing; and
extraction means for removing signage stored within the housing.

14. The system of claim 11 wherein the housing comprises:
a length of approximately sixty (60) inches;
a width of approximately twelve (12) inches; and
a depth of approximately four (4) inches.

15. The system of claim 14 wherein the housing comprises a plastic material.

16. The system of claim 11 further comprising a rubber seal coupled to the clear plastic material and operable to seal the cavity from environmental elements.

17. The system of claim 16 further comprising a second rubber seal coupled to a rear of the housing and operable to securely couple the rear portion of the housing to the motor vehicle.

18. A luminescent motor vehicle signage system comprising:
a rectangular housing operable to be coupled to an exterior portion of an automobile, the rectangular housing including a spring loaded access panel positioned at a first end of the rectangular housing and operable to remove and replace a removable opaque signage;
a fluorescent illumination chamber positioned behind the opaque signage and operable to illuminate the removable opaque signage when placed within the rectangular housing; and
a rubber seal coupled to a rear portion of the rectangular housing and operable to protect contents within the rectangular housing from environmental elements.

19. The system of claim 18 wherein the rectangular housing includes a clear plastic material coupled along a front portion of the housing and operable to protect contents from the environmental elements.

20. The system of claim 19 further comprising a motor vehicle mount fixture coupled to the rear portion of the housing and operable to mount the rectangular housing to the motor vehicle.
